(19) United States
(12) Patent Application Publication
(10) Pub. No.: US 2022/0066300 A1
(43) Pub. Date: Mar. 3, 2022

(54) PROJECTION UNIT AND SCANNER ACCESSORIES

(71) Applicant: Hewlett-Packard Development Company, L.P., Spring, TX (US)

(72) Inventor: Sook Min Park, Palo Alto, CA (US)

(73) Assignee: Hewlett-Packard Development Company, L.P., Spring, TX (US)

(21) Appl. No.: 17/419,076

(22) PCT Filed: May 22, 2019
(86) PCT No.: PCT/US2019/033621

§ 371 Date: Jun. 28, 2021

(51) Int. Cl. G03B 21/14; G06F 3/042; G06F 3/01; G06F 3/14; H04N 9/31; H04N 5/225; G03B 17/54; G06F 1/16

(52) U.S. Cl. CPC G03B 21/145; G06F 3/0425; G06F 3/017; G06F 3/1446; H04N 9/3141; G06F 1/1616; G03B 17/54; G06F 1/1639; G06F 1/1647; G06F 1/1686; G06F 1/1624; H04N 5/2257

(57) ABSTRACT

An example of an apparatus is provided. The apparatus includes a mounting mechanism to engage with a portable computing device. The portable computing device is to rest on a surface. The apparatus also includes a camera connected to the mounting mechanism. The camera is to scan an area on the surface. In addition, the apparatus includes a projection unit connected to the mounting mechanism, wherein the projection unit is to project an image on the surface. The apparatus includes a communication interface in communication with the camera and the projection unit. The communication interface is to communicate with the portable computing device.

### BACKGROUND

Projection units may be used to display content on a surface. In particular, projection units may be used to project images to present information to an audience. Projection units may also be used to display content as an alternative to a display screen. Scanners and cameras may be used to capture image data. The image data may be based on optical signals from the environment detected by the scanner or camera.

### BRIEF DESCRIPTION OF THE DRAWINGS

Reference will now be made, by way of example only, to the accompanying drawings in which:

FIG. 1A is a perspective view from the bottom of an example apparatus to project a second display from a portable computing device;

FIG. 1B is a perspective view from the top of an example apparatus to project a second display from a portable computing device;

FIG. 2 is a schematic representation of the electronic components of the apparatus of FIG. 1A and FIG. 1B;

FIG. 3A is a perspective view from the front of an example portable computing device to project a second display with the projection unit in a position;

FIG. 3B is a perspective view from the back of an example portable computing device to project a second display with the projection unit in another position;

FIG. 3C is a cross sectional view of a portion of the portable computing device;

FIG. 4 is a perspective view from the front of another example portable computing device to project a second display with the projection unit mounted on an extension arm; and

FIG. 5 is a flowchart of an example of a method of projecting a second display from a portable computing device.

### DETAILED DESCRIPTION

As used herein, any usage of terms that suggest an absolute orientation (e.g. “top”, “bottom”, “vertical”, “horizontal”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

Computer systems have become widely used in many different industries. In particular, computer systems are often used by people with “desk jobs.” Modern computer systems generally have multiple screens to provide additional space when running multiple applications on the computer system, such as an email application, a word processing application, and a web browsing application. Additional screen space may also be useful when multiple documents are to be viewed at the same time. For example, a researcher or analyst may want to view multiple documents for comparison purposes without switching between application windows on a limited screen. As another example, users in a collaborative work environment may wish to share a screen to distribute information, such as a presentation, while maintaining a private screen to carry on other functions, such as taking notes from the presentation.

As more users move to mobile platforms to allow for work to be done on smaller devices at any location, the benefits of a second screen may be lost. For example, a user may typically carry a laptop or other portable computing device to work remotely, such as in a coffee shop, a hotel room, or at another office location. The laptop or other portable computing device typically has a single screen and thus productivity may be reduced for a user accustomed to working on a computer system with multiple screens. Similarly, if the user is in a remote collaborative setting outside of a conference room where the user intends to share the contents of a screen on the laptop or other portable computing device to another person, the user may have to turn the laptop back and forth so that the screen may be seen by another person collaborating with the user. Thus, in some situations, it may be desirable to have an apparatus to provide a second display from the laptop that is portable and lightweight that may be used on most surfaces. In particular, an apparatus that may be lightweight and attached and re-attached to a laptop or other portable computing devices to generate an additional display may be used instead of larger monitors, such as a desktop monitor, or presentation projector units.

An apparatus to project a second display from a portable computing device is provided. The apparatus is to be mounted on the portable computing device and to project an image onto a surface on which the portable computing device rests. Accordingly, the apparatus is to make use of space on the surface to generate an image to function as a second display. In one example, the apparatus may be an accessory for a portable computing device and is to have a small form factor, and be lightweight such that it may be mounted onto a portable computing device without any additional stands or supports to be used in a remote setting where a user may have a simple desk, table, or other surface on which to work remotely.

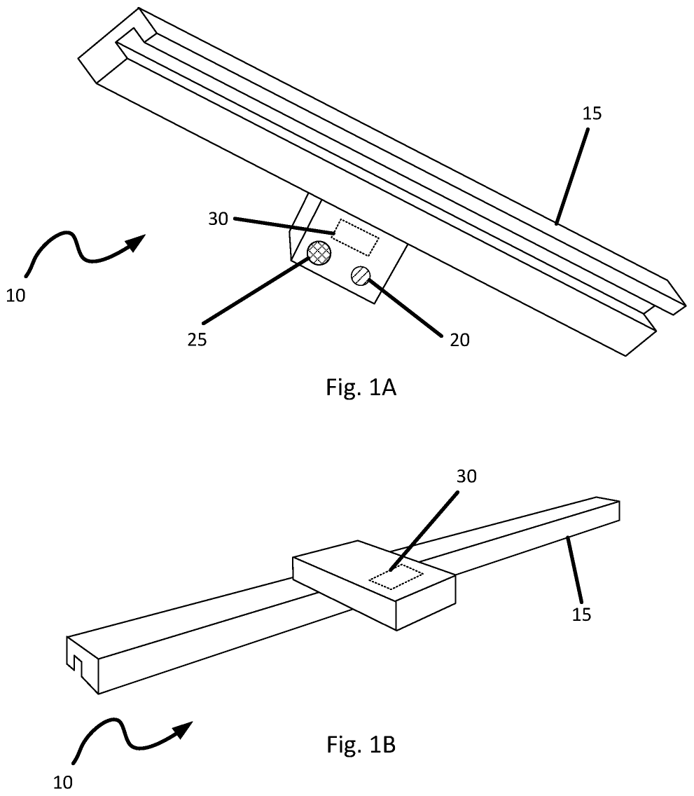

Referring to FIG. 1A and FIG. 1B, an apparatus 10 to project a second display from a portable computing device is provided. Since the apparatus 10 is intended for mobile work applications, the apparatus 10 may be compact for convenient storage and designed to engage a portable computing device, such as a laptop, a tablet, a smartphone, or, in some cases, a personal computer. In this example, the apparatus 10 is to project a second display onto the surface on which the portable computing device is resting while in use. The apparatus 10 includes a mounting mechanism 15, a camera 20, a projection unit 25, and a communications interface 30.

In the present example, the mounting mechanism 15 is to engage with a portable computing device. For example, the mounting mechanism 15 may be to engage with an edge of a screen or display unit of the portable computing device while the portable computing device rests on a surface, such as a desktop or tabletop. The mounting mechanism 15 is to secure the apparatus 10 to the edge of a screen. In particular, the mounting mechanism 15 is to rigidly attach along the edge of the screen to position the camera 20 and the projection unit 25 at a fixed position relative to the surface on which the portable computing device is resting. The manner by which the mounting mechanism 15 engages the edge of a screen is not particularly limited. In the present example, the mounting mechanism 15 may include a slot to engage with the top edge of the screen of a portable computing device. The mounting mechanism 15 may be used to hook the apparatus 10 over the top edge of the screen. In other examples, the mounting mechanism 15 may provide a friction fit over an edge of the screen. In further examples, the mounting mechanism 15 may include a biasing element to clamp the apparatus along the edge of the screen. For example, the mounting mechanism 15 may include spring loaded biasing element to secure to the screen. In further examples, the mounting mechanism 15 may include a pliable material, such as plastic that may be deformed to fit over the edge. In other examples, the mounting mechanism 15 may engage with a complimentary mating mechanism on the portable computing device, such as a magnetic mounting mechanism. Other mechanisms such as a hook-and-pile, friction fit, screws, bolts and others are also contemplated.

Although in the present example the mounting mechanism 15 is engaged to the top edge of the screen, it is to be appreciated that the mounting mechanism 15 may be engaged to the portable computing device at other locations. For example, the mounting mechanism 15 may engage to a side edge of the screen, or to a single mounting point elsewhere on the portable computing device. Furthermore, although the camera 20 and the projection unit 25 is illustrated as part of a single unit in FIG. 1A and FIG. 1B, the camera 20 and the projection unit 25 may be separated such that they are positioned at different locations on the mounting mechanism 15.

The camera 20 is connected to the mounting mechanism 15. In the present example, the camera 20 is to scan an area of the surface on which the portable computing device rests. Accordingly, the camera 20 may scan the surface to collect image data for the subsequent processing to identify input. In an example, the camera 20 may scan an area to receive commands, such as in the form of a gesture or based on written or printed documents placed in view of the camera 20. The gestures detected by the camera 20 are not limited and may include detecting hand gestures or movements of another device, such as following the motion of a stylus.

In the present example, the projection unit 25 is connected to the mounting mechanism 15. The projection unit 25 is to project an image on the surface on which the portable computing device rests. Accordingly, the projection unit 25 may be used to provide an additional display for the portable computing device. The images projected by the projection unit 25 are not particularly limited. For example, the image projected may be an extension of the display of portable computing device. Accordingly, the projection unit 25 may provide a second display area as an alternative to a second display screen on the surface beside the portable computing device. This feature may allow the user to have an experience similar to the experience in an office, where there may be a second display screen to open multiple application windows or documents. In another example, the image projected by the projection unit 25 may be a duplicate of the display of portable computing device. Accordingly, the projection unit 25 may provide a second screen on the surface beside the portable computing device for others to view. This feature will allow the user to display content to other people on a nearby surface, such as a tabletop, when working in a collaborative environment as an alternative to using a projector system in a conference room.

In this example, it is to be appreciated that the camera 20 and the projection unit 25 may be used in combination with each other to provide a way of generating output and receiving input. For example, if an image is projected onto a surface with the projection unit 25, the camera 20 may be used to detect input and track movements, such as hand gestures, or movement of a pointing device, such as a stylus or pen over the image projected by the projection unit 25. Accordingly, the image projected by the projection unit 25 onto the surface on which the portable computing device rests may be used as an interactive display similar to a touchscreen device. In other examples, it is to be understood that the camera 20 may be directed to an area other than the image projected by the projection unit 25 to receive input. In particular, the camera 20 may also be directed to the user of the portable computing device or elsewhere.

The communications interface 30 is in communication with the camera 20 and the projection unit 25. Furthermore, the communications interface 30 is to communicate with the portable computing device. In particular, the communications interface 30 is to transmit the image data received by the camera 20 to the portable computing device and to receive display data from the portable computing device to be projected by the projection unit 25. The manner by which the communications interface 30 transmits and receives data is not particularly limited. For example, the communications interface 30 may transmit and receive the content over a wireless connection such as WiFi or Bluetooth. In some examples, the apparatus 10 may be connected to a cloud server to display image data and capture image data to be shared with other devices, which may be used for the purposes of collaboration among multiple parties. In other examples, the communications interface 30 may provide a wired connection, such as via a universal serial bus (USB), to the portable computing device.

The manner by which the communications interface 30 transmits and receives data with the portable computing device is not particularly limited. In the present example, the apparatus 10 may be an accessory of the portable computing device and primarily controlled by the portable computing device. In other examples where the apparatus 10 may be a collaboration tool, the apparatus 10 may be managed by a central server located at a remote location and the apparatus 10 may be one of many apparatuses broadly distributed over a large geographic area during a collaboration session. Such an example may be particularly suitable for collaboration of multiple parties who are each working remotely, such as at home, may want to share and receive content from another party's portable computing device during a virtual meeting.

Accordingly, the apparatus 10 may provide a user with the ability to simulate an office environment when working remotely on a portable computing device. In particular, the apparatus 10 may provide a second display for the user of the portable computing device such that the user may open windows on the display screen of the portable computing device and open other windows on the projected image acting as a second screen to view multiple documents. In addition, the apparatus 10 may provide the ability to project an image onto a surface for other parties near the surface to view.

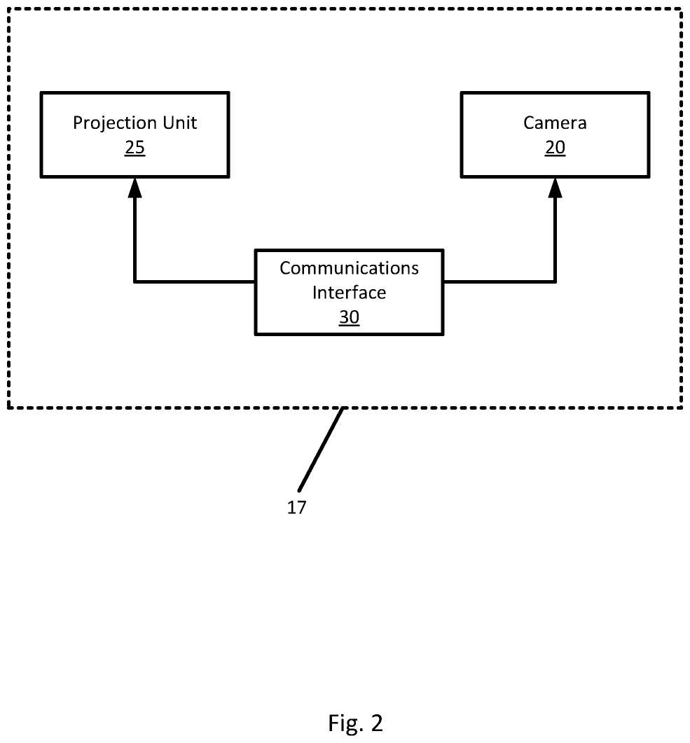

Referring to FIG. 2, a schematic representation of the electronic components of the apparatus 10 is illustrated. In the present example, the camera 20, the projection unit 25, and the communications interface 30 may be place in a single housing 17 to protect the components. In the present example, the projection unit 25 is to project an image onto the surface on which the portable computing device rests, such as onto an area on the surface near the portable computing device. For video playback or for motions on the displayed image, such as a pointer movement, typing, or animation, the projection unit 25 is to refresh the image from time to time. The manner by which the projection unit 25 projects a moving image is not particularly limited. For example, the projection unit 25 may periodically refresh the image after a fixed period of time such as after about each second, about every 0.50s, about every 0.25 s, or about every 0.10 s. In order for movements on the display projected by the projection unit 25 to appear seamless to the human eye, the refresh rate may be about every 0.015 s. In other examples, the projection unit 25 may refresh the image after variable amounts of time, such as when motion is to be shown. By increasing the amount of time between when the display unit is refreshed, the amount of resources used to render the display images may be reduced.

In the present example, the camera 20 is to capture image data of the surface onto which the projection unit 25 projects an image. In particular, the camera 20 is to capture image data from the surface onto which the projection unit 25 projects an image in real time and transmit the image data to the portable computing device via the communications interface 30 for processing. The camera 20 may subsequently capture updated image data in real time. The manner by which the camera 20 captures real time image data is not particularly limited. For example, the camera 20 may periodically take image data after a fixed period of time such as after about each second, about every 0.50 s, about every 0.25 s, or about every 0.10 s. It is to be appreciated that the period of time between each image capture is not limited and may be increased to reduce the use of computational resources, or decreased to capture more image data for a smoother video feed.

In some examples, the camera 20 may include additional sensor and optical components (not shown) to measure image data over a wide variety of lighting conditions. In some examples, the apparatus 10 may be equipped with multiple cameras where each camera 20 may be designed to cover different fields of view of the surface or to cover different operating conditions, such as varying lighting.

Similarly, the projection unit 25 may include additional sensor and optical components (not shown) to measure lighting conditions and to focus the image onto the surface. In some examples, the apparatus 10 may be equipped with multiple projection units where each projection unit 25 may be designed to cover different areas on the surface to provide a larger display area.

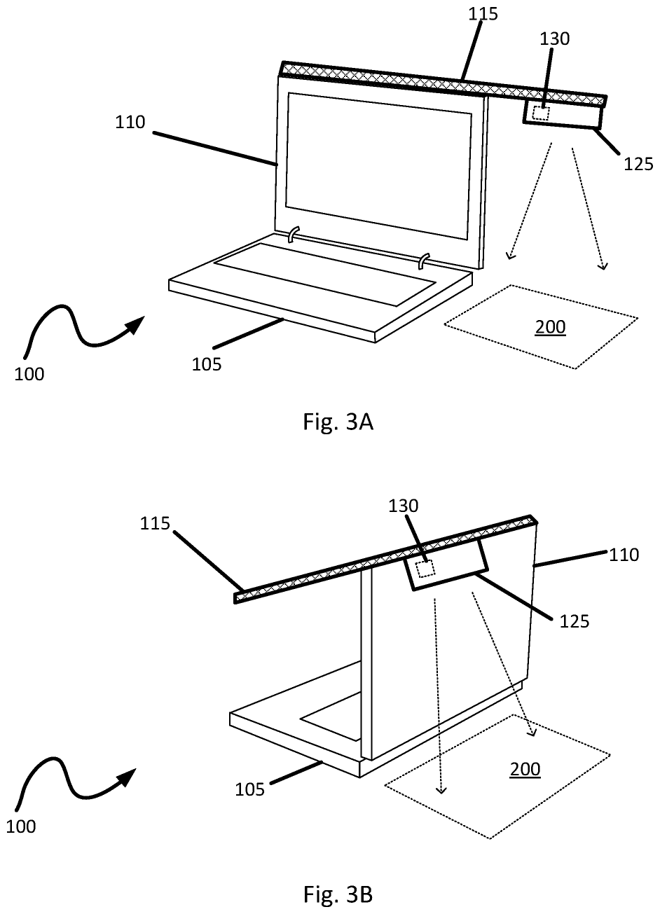

Referring to FIG. 3A and FIG. 3B, a portable computing device 100 to project a second display image 200 is illustrated. In the present example, the portable computing device 100 is intended for mobile work applications and may be compact for convenient storage and lightweight for carrying. In this example, the portable computing device 100 is a laptop, but in other examples, the portable computing device 100 may be a portable computer, a tablet, or, in some cases, a smartphone. In particular, the portable computing device 100 is to project a second display image 200 onto a small area on a surface which the portable computing device 100 is resting while in use. The apparatus includes a base unit 105, a display unit 110, a mounting mechanism 115, a projection unit 125, and a communications interface 130.

In the present example, the base unit 105 is to rest on a surface when the portable computing device 100 is in use. In particular, the base unit 105 may be to support the display unit 110 and other components in a fixed position relative to the surface so that the second display image 200 may be projected at a fixed and steady location on the surface. In the present example where the portable computing device 100 is a laptop computer, the base unit 105 may be the processing unit of the laptop having a keyboard input device and a processor within the base unit 105. In this example, the processor may be used to process data and to render display data for the display unit 110 and the projection unit 125. In other examples such as when the portable computing device 100 is a tablet, the base unit 105 may be a stand to support the tablet with a keyboard or touchpad input. Further examples may have the display data rendered at display unit 110 or the projection unit 125. In another example, the rendered display data may be received from an external source, such as via a network, or pre-rendered data from a memory storage unit.

The display unit 110 is to display a rendered output image. In the present example where the portable computing device 100 is a laptop computer, the display unit 110 is a screen of the laptop. The display unit 110 is not particularly limited and the manner by which the display unit displays the output image may involve any type of display device. For example, the display unit 110 may include one or more light emitters and modulating components such as an array of light emitting diodes (LED), liquid crystals, plasma cells, or organic light emitting diodes (OLED). Other types of light emitters and modulators may also be substituted. Furthermore, a touch membrane (not shown) may be overlaid on the display unit 110 to provide a touchscreen input device for the portable computing device 100. The touch membrane is not limited to any type of touch membrane and may include resistive technology, surface acoustic wave technology, capacitive technology, infrared technology, or optical imaging technology.

In the present example, the display unit 110 is pivotally connected to the base unit 105. The manner by which the display unit 110 is to be pivotally connected to the base unit 105 is not particularly limited. For example, display unit 110 may be connected by a hinge. The hinge may hold the display unit 110 in a position using friction in order to support other components attached to the display unit 110, such as the projection unit 125. In other examples, another locking mechanism may be used, such as a fastener, a latch, or set screw. In other examples, the hinge may be substituted with other mechanisms to pivotally or otherwise moveably connect the display unit 110 to the base unit 105. In further examples, the base unit 105 may be a stand and used to support the display unit 110 without a physical connection.

The display unit 110 is to be held generally upright by the base unit 105 and typically at an angle for comfortable viewing by a user of the portable computing device 100. Accordingly, the angle may be about 10 degrees off the normal to the surface on which the base unit 105 rests. In other examples, the angle may be about 15 degrees or about 20 degrees.

The mounting mechanism 115 is to engage with an edge of the display unit 110. For example, the mounting mechanism 115 may be to engage with an edge of a screen of the portable computing device 100. In the present example, the mounting mechanism 115 is to secure rigidly along an edge of the display unit 110. The manner by which the mounting mechanism 115 engages the edge of the display unit 110 is not particularly limited. In the present example, the mounting mechanism 115 may include a slot to engage with the top edge of the display unit 110 of a portable computing device 100 such that the projection unit 125 may project an image onto the surface on which the base unit 105 rests. Although in the present example the mounting mechanism 115 is to be engaged to the top edge of the display unit 110, it is to be appreciated that the mounting mechanism 15 may be engaged to the portable computing device 100 at other locations. For example, the mounting mechanism 115 may engage to a side edge or to a single mounting point on the display unit 110. In other examples, the mounting mechanism 115 may also engage the base unit 105 or be a separate free standing structure to be placed near the portable computing device 100.

Referring to FIG. 3C, a rail 116 may be disposed on the mounting mechanism 115. The rail 116 is to provide for adjustments to the portable computing device 100 such that the second display image 200 may be projected beside the display unit 110 to serve as an addition display for the user of the portable computing device 100 or projected behind the display unit 110 to serve as a presentation display for collaborative purposes for other parties to view. Accordingly, in the present example, the rail 116 is to extend in a horizontal orientation, such as along the top edge of the display unit 110.

In the present example, the projection unit 125 is slidably mounted to the mounting mechanism 115 via the rail 116. The projection unit 125 is to project an image on the surface on which the portable computing device 100 rests. Accordingly, the projection unit 125 may be used to provide a second display image 200 for the portable computing device 100 which may be used for to open addition windows within an operating system or as a presentation display for other parties in close proximity to the portable computing device 100, such as people sitting around a table or desk.

Furthermore, the projection unit 125 may be pivotally mounted to the mounting mechanism 115 to allow for adjustments to the display image 200 being projected, such as for adjusting the location of the second display image 200. For example, the projection unit 125 may be connected to the rail 116 via a hinge 118. This may provide for pivotal motion of the projection unit 125 within a plane. The projection unit 125 may be held in place at the hinge 118 using friction or another locking mechanism using a fastener such as a latch or set screw. In other examples, the hinge 118 may be substituted with a ball joint to allow for a larger degree of motion. The locations where the second display image 200 may be projected is not limited. For example, the second display image 200 may be projected beside the portable computing device 100 (as in FIG. 3A), or behind the portable computing device 100 (as in FIG. 3B). In other examples, the second display image 200 may be projected elsewhere or at a greater distance from the portable computing device 100.

The communications interface 130 is in communication with the projection unit 125. Furthermore, the communications interface 130 is to communicate with a processor in the base unit 105 of the portable computing device 100. In particular, the communications interface 130 is to receive display data from the base unit 105 to be projected by the projection unit 125. The manner by which the communications interface 130 receives the display data is not particularly limited. For example, the communications interface 130 may receive the content over a wireless connection such as WiFi or Bluetooth. In other examples, the communications interface 130 may provide a wired connection, such as via a USB cable, to the base unit 105. In examples, the communications interface 130 may be connected to a cloud server either via the base unit 105 or via a wireless network to receive display image data shared from other devices, which may be used for the purposes of collaboration among multiple parties.

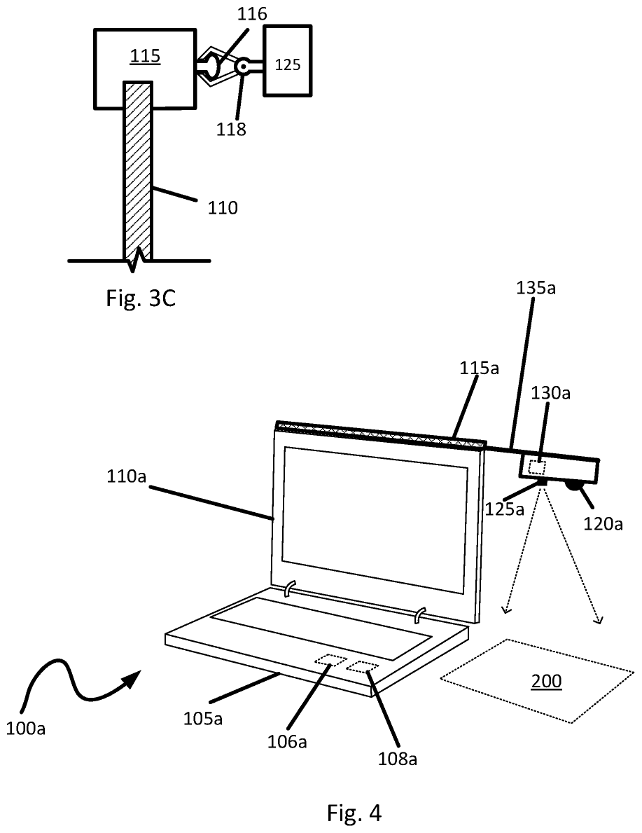

Referring to FIG. 4, another example of a portable computing device 100a to project a second display image 200 is illustrated. Like components of the portable computing device 100a bear like reference to their counterparts in the portable computing device 100, except followed by the suffix “a.” In this example, the portable computing device 100a is a laptop and a base unit 105a, a display unit 110a, a mounting mechanism 115a, a camera 120a, a projection unit 125a, a communications interface 130a, and an arm 135a.

In the present example, the base unit 105a is to rest on a surface when the portable computing device 100a is in use. In particular, the base unit 105a may be to support the display unit 110a and other components in a fixed position relative to the surface so that the second display image 200 may be projected at a fixed and steady location on the surface. In the present example where the portable computing device 100a is a laptop computer, the base unit 105a may be the processing unit of the laptop having a keyboard input device, a processor 106a, and a memory storage unit 108a within the base unit 105a. In this example, the processor 106a may be used to process image data received from the camera 120a and to render display data for the projection unit 125a.

The memory storage unit 108a is coupled to the processor 106a and is to receive image data from the camera 120a and to store data generated by the processor 106a. In addition, the memory storage unit 108a may be encoded with instructions executable by the processor 106a to carry out various functions with the camera 120a, the projection unit 125a and other components of the portable computing device 100a. The memory storage unit 108a is not particularly limited and may include a non-transitory machine-readable storage medium that may be any electronic, magnetic, optical, or other physical storage device. For example, the non-transitory machine-readable storage medium may include random access memory (RAM), electrically-erasable programmable read-only memory (EEPROM), flash memory, a storage drive, an optical disc, and the like. The machine-readable storage medium may also be encoded with executable instructions to carry out a method of converting a physical document with markings into an electronic document.

Furthermore, the memory storage unit 108a may also store an operating system that is executable by the processor 106a to provide general functionality to the portable computing device 100a, including functionality to support applications to operate the camera 120a and the projection unit 125a. Examples of operating systems include Windows™, macOS™, iOS™, Android™, Linux™, and Unix™. The memory storage unit 108a may additionally store drivers that are executable to provide additional functionality to the portable computing device 100a, such as operating the display unit 110a and other peripheral devices (not shown).

The arm 135a may be to connect the camera 120a and the projection unit 125a to the mounting mechanism 115a. The arm 135a is not particularly limited and may be used to extend the range of motion of the camera 120a and the projection unit 125a. For example, the arm 135a may be used in place of a rail to provide adjustment capability for the camera 120a and the projection unit 125a. In other examples, the arm 135a may be an extension from the rail to further increase the range of motion.

In the present example, the camera 120a is connected to the arm 135a. In the present example, the camera 120a is to scan an area of the surface on which the portable computing device 100a rests. Accordingly, the camera 120a may scan the surface to collect image data for the subsequent processing to identify input. In an example, the camera 120a may scan an area to receive gesture commands generated or provided on or near the second display image 200. Accordingly, the camera 120a may scan the area to provide an alternative way of receiving input, such as following the motion of a stylus (not shown).

In this example, the camera 120a and the projection unit 125a may be used in combination with each other to provide a way of generating output and receiving input. For example, if the second display image 200 is projected onto a surface close to the display unit 110a with the projection unit 125a, the camera 120a may be used to detect input and track movements over the second display image 200, such as hand gestures, or movement of a pointing device, such as a stylus or pen. Accordingly, the second display image 200 projected onto the surface on which the portable computing device 100a rests may be used as an interactive display on the surface similar to a touchscreen.

Although the present example is directed to a 2D display image 200, it is to be appreciated that further examples are contemplated. For example, the camera 120a and the projection unit 125a may be used as a 3D scanner to generate a virtual representation of an object in a field of view.

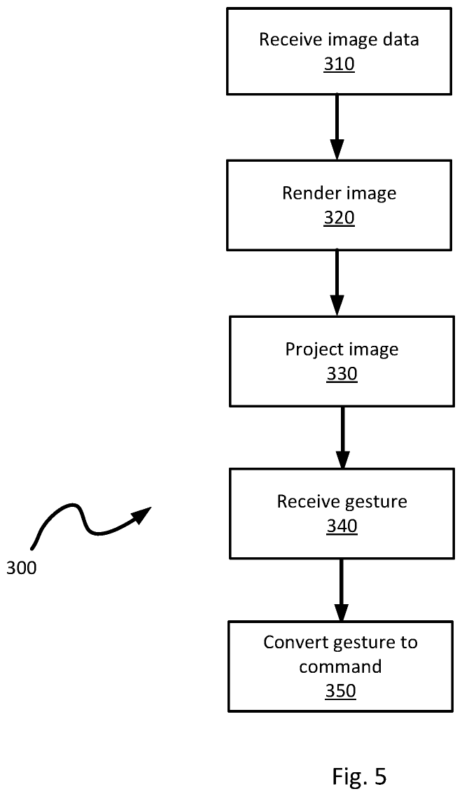

Referring to FIG. 5, a flowchart of a method of projecting an image on a surface on which a portable computing device 100a rests is generally shown at 300. In order to assist in the explanation of method 300, it will be assumed that method 300 may be performed with the portable computing device 100a. Indeed, the method 300 may be one way in which portable computing device 100a may be configured. Furthermore, the following discussion of method 300 may lead to a further understanding of the portable computing device 100a and its various components. Furthermore, it is to be emphasized, that method 300 may not be performed in the exact sequence as shown, and various blocks may be performed in parallel rather than in sequence, or in a different sequence altogether.

Block 310 involves receiving image data to be displayed by the projection unit 125a. The image data is not particularly limited and may be generated by the processor 106a or another component within the base unit 105a, such as a second video processor. In other examples, the image data may be received in a pre-rendered format from an external source, such as from a server via a network. For example, the image data may represent output to be generated at the portable computing device 100a during normal operation by a user. In particular, the image data may represent windows of applications with which the user is interacting. Applications may include word processing applications, software development applications, monitoring applications, gaming applications or other entertainment applications.

In block 320, the processor 106b is to render a display image 200 from the image data. The display image 200 is to be generated and projected by the projection unit 125a. It is to be appreciated that the display image may be a portion of the image data received at block 310 and that the processor 106b may separate the data associated with the display image to be projected by the projection unit 125a. The remaining image data may be for another display image, such as an image to be displayed by the display unit 110a or another output device, such as an additional screen or projection unit.

Block 330 involves projecting the display image 200 onto the surface on which the base unit 105a is resting. The display image 200 is to be projected by the projection unit 125a and is to be associated an image displayed on the display unit 110a. For example, the display image 200 may be an extension of the image displayed on the display unit 110a. In another example, the display image 200 may be a duplicate image to allow other parties to work in a collaborative environment.

Block 340 involves receiving a gesture over the display image. In the present example, the gesture may be captured using the camera 120a. For example, the camera 120a may scan capture hand gesture commands to control the portable computing device 100a or to provide input such as pointing commands or character inputs. In another example, the camera 120a may scan an area over the display image 200 to for an active or passive stylus device.

Block 350 involves converting the gesture to a command. In this example, the processor 106a may compare the gesture received by the camera 120a to a database of known gestures. The gesture may then be converted to a command by the processor 106a. The commands are not limited and may include commands to control aspects of the portable computing device 100a. For example, the command may be to adjust screen settings, power options, or volume controls of the portable computing device 100a. In other examples, the commands may represent input for an application, such as a selection from a menu, a response to a prompt, or general input such as typing a text string or drawing an image.

It should be recognized that features and aspects of the various examples provided above may be combined into further examples that also fall within the scope of the present disclosure.

What is claimed is:

1. An apparatus comprising:
a mounting mechanism to engage with a portable computing device, wherein the portable computing device is to rest on a surface;
a camera connected to the mounting mechanism, wherein the camera is to scan an area on the surface;
a projection unit connected to the mounting mechanism, wherein the projection unit is to project an image on the surface; and
a communication interface in communication with the camera and the projection unit, wherein the communication interface is to communicate with the portable computing device.

2. The apparatus of claim 1, further comprising a rail to connect the mounting mechanism to the projection unit.

3. The apparatus of claim 2, wherein the projection unit is slidable along the rail.

4. The apparatus of claim 3, wherein the projection unit is pivotably connected to the rail.

5. The apparatus of claim 1, wherein the communication interface is to communicate with the portable computing device wirelessly.

6. The apparatus of claim 1, wherein the image is an extension of a display of the portable computing device.

7. The apparatus of claim 1, wherein the image is a duplicate of a display of the portable computing device.

8. A portable computing device comprising:
a base unit to rest on a surface;
a display unit pivotally connected to the base unit, wherein the display unit is to display a rendered output image;
a mounting mechanism to engage with an edge of the display unit;
a rail disposed on the mounting mechanism, wherein the rail is to extend along the edge of the display unit;
a projection unit slidably mounted to the rail, wherein the projection unit is to project an image on the surface; and
a communication interface in communication with the projection unit, wherein the communication interface is to receive image data to be projected by the projection unit.

9. The portable computing device of claim 8, further comprising an arm to connect the mounting mechanism to the projection unit, wherein the arm is to extend a range of motion of the projection unit from the display unit.

10. The portable computing device of claim 9, further comprising a camera mounted on the arm proximate to the projection unit, wherein the camera is to scan an area of the surface.

11. The portable computing device of claim 10, wherein the camera is to capture a command generated on the surface.

12. The portable computing device of claim 11, wherein the projection unit is pivotably connected to the rail to adjust the image.

13. A non-transitory machine-readable storage medium encoded with instructions executable by a processor, the non-transitory machine-readable storage medium comprising:
instructions to receive image data to display via a projection unit, wherein the projection unit is mounted on a display unit;
instructions to render a second display image from the image data with the processor in a base unit, wherein the base unit is to rest on a surface;
instructions to project the second display image on the surface with the projection unit, wherein the display unit is to output a first display image;
instructions to receive a gesture over the second display image with a camera; and
instructions to convert the gesture to a command at the processor.

14. The non-transitory machine-readable storage medium of claim 13, further comprising instructions to project the second display image as an extension of the first display image.

15. The non-transitory machine-readable storage medium of claim 13, further comprising instructions to project the second display image as an duplicate of the first display image.
